(19) United States
(12) Patent Application Publication
(10) Pub. No.: US 2025/0340402 A1
(43) Pub. Date: Nov. 6, 2025

(54) DETECTION OF OBJECTS ASSOCIATED WITH AN ELEVATOR CAR

(71) Applicant: KONE Corporation, Helsinki (FI)

(72) Inventors: Mari Zakrzewski, Helsinki (FI); Ari Pitkänen, Helsinki (FI)

(73) Assignee: KONE Corporation, Helsinki (FI)

(21) Appl. No.: 19/270,003

(22) Filed: Jul. 15, 2025

Related U.S. Application Data
(63) Continuation of application No. PCT/EP2023/052937, filed on Feb. 7, 2023.

(51) Int. Cl. B66B 5/00; B66B 1/34; B66B 13/22; G01S 7/48; G01S 17/89

(52) U.S. Cl. CPC B66B 5/0012; B66B 1/3476; B66B 13/22; G01S 7/4802; G01S 17/89

(57) ABSTRACT

According to an aspect, there is provided a solution in which sensor data relating to both real objects sensed by at least one sensor associated with an elevator car and reflection objects of the real objects may be used in determining at least one characteristic associated with an interior space and/or exterior space of the elevator car.

### TECHNICAL FIELD

Various example embodiments generally relate to the field of elevator systems. In particular, some example embodiments relate to a solution for detecting objects based on sensor data provided by at least one sensor arranged in an elevator car.

### BACKGROUND

One or more sensors may be arranged inside an elevator car to sense objects in the elevator car. For example, a camera may be arranged in a ceiling of the elevator car to provide a wide angle view of the room inside the elevator car. The image provided by the camera may then be analyzed, for example, to provide information on the number of passengers in the elevator car. One challenge of the image data provided by the camera is that there may not always be a direct line of sight to objects or people inside the elevator car. For example, a large object may block a smaller object and thus the smaller object may not be detected based on the image data. Further, one or more of the surfaces inside the elevator car may be reflective, thus causing reflections in the data recorded by the sensors. For example, there can be one or more mirrors on the walls, and wall, door, and floor materials itself may be very reflective. Thus, it may be challenging to provide a detailed and accurate analysis based on the data from the sensors.

### SUMMARY

According to a first aspect, there is provided a method that comprises obtaining sensor data from at least one sensor arranged in an elevator car having at least one reflective surface; performing object detection of at least one object for each sensor of the at least one sensor based on the sensor data; separating reflection objects among the at least one object from real objects among the at least one object based at least partly on the object detection and elevator car dimensions, a reflection object being caused by the at least one reflective surface and having a three-dimensional location outside the elevator car; associating each reflection object with a corresponding real object, forming at least one combined object, each combined object of the at least one combined object comprising data relating to a real object and/or at least one reflection object associated with the real object; and analyzing the data relating to the at least one combined object to determine at least one characteristic associated with an interior space and/or exterior space of the elevator car.

In an implementation form of the first aspect, separating reflection objects among the at least one object from real objects among the at least one object based at least partly on the object detection and elevator car dimensions comprises: determining a three-dimensional location of the at least one object based on the sensor data; and separating the reflection objects the at least one object from the real objects among the at least one object based at least partly on the three-dimensional location of the at least one object and the elevator car dimensions.

In an implementation form of the first aspect, the method further comprises determining that the data relating to the at least one combined object identifies at least one passenger; and determining the at least one characteristic based on the data, wherein the at least one characteristic comprises the number of passengers in the elevator car.

In an implementation form of the first aspect, the at least one characteristic comprises information identifying a passenger type in the elevator car.

In an implementation form of the first aspect, the at least one characteristic comprises information identifying an object type in the elevator car.

In an implementation form of the first aspect, the at least one characteristic comprises an indication of an open elevator door.

In an implementation form of the first aspect, the at least one characteristic comprises an indication of a closed elevator door.

In an implementation form of the first aspect, the at least one characteristic comprises information about at least one object outside the elevator car in a lobby area.

In an implementation form of the first aspect, the at least one sensor comprises at least one of the following: a camera, a time of flight camera, a lidar, a radar, and a thermal camera.

In an implementation form of the first aspect, the method further comprises classifying the at least one real object based on the at least one characteristic.

According to a second aspect, there is provided an apparatus comprising at least one processor and at least one memory storing instructions that, when executed by the at least one processor, cause the apparatus to at least perform: obtaining sensor data from at least one sensor arranged in an elevator car having at least one reflective surface; performing object detection of at least one object for each sensor of the at least one sensor based on the sensor data; separating reflection objects among the at least one object from real objects among the at least one object based at least partly on the object detection and elevator car dimensions, a reflection object being caused by the at least one reflective surface and having a three-dimensional location outside the elevator car; associating each reflection object with a corresponding real object, forming at least one combined object, each combined object of the at least one combined object comprising data relating to a real object and/or at least one reflection object associated with the real object; and analyzing the data relating to the at least one combined object to determine at least one characteristic associated with an interior space and/or exterior space of the elevator car.

In an implementation form of the second aspect, the at least one memory stores instructions that, when executed by the at least one processor, cause the apparatus to at least perform: determining a three-dimensional location of the at least one object based on the sensor data; and separating the reflection objects among the at least one object from the real objects among the at least one object based at least partly on the three-dimensional location of the at least one object and the elevator car dimensions.

In an implementation form of the second aspect, the at least one memory stores instructions that, when executed by the at least one processor, cause the apparatus to at least perform: determining that the data relating to the at least one combined object identifies at least one passenger; and determining at least one characteristic based on the data, wherein the at least one characteristic comprises the number of passengers in the elevator car.

In an implementation form of the second aspect, the at least one characteristic comprises information identifying a passenger type in the elevator car.

In an implementation form of the second aspect, the at least one characteristic comprises information identifying an object type in the elevator car.

In an implementation form of the second aspect, the at least one characteristic comprises an indication of an open elevator door.

In an implementation form of the second aspect, the at least one characteristic comprises an indication of a closed elevator door.

In an implementation form of the second aspect, the at least one characteristic comprises information about at least one object outside the elevator car in a lobby area.

In an implementation form of the second aspect, the at least one sensor comprises at least one of the following: a camera, a time of flight camera, a lidar, a radar, and a thermal camera.

In an implementation form of the second aspect, the at least one memory stores instructions that, when executed by the at least one processor, cause the apparatus to at least perform: classifying the at least one real object based on the at least one characteristic.

According to a third aspect, there is provided a computer program comprising instructions which, when the program is executed by at least one processor, cause an apparatus to perform the method of the first aspect.

According to a fourth aspect, there is provided a computer-readable medium comprising a computer program comprising instructions which, when the program is executed by at least one processor, cause an apparatus to perform the method of the first aspect.

According to a fifth aspect, there is provided an elevator system comprising an apparatus according to the second aspect and at least one sensor arranged in an elevator car and configured to provide sensor data to the apparatus.

According to a sixth aspect, there is provided an apparatus comprising means for: obtaining sensor data from at least one sensor arranged in an elevator car having at least one reflective surface; performing object detection of at least one object for each sensor of the at least one sensor based on the sensor data; separating reflection objects among the at least one object from real objects among the at least one object based at least partly on the object detection and elevator car dimensions, a reflection object being caused by the at least one reflective surface and having a three-dimensional location outside the elevator car; associating each reflection object with a corresponding real object, forming at least one combined object, each combined object of the at least one combined object comprising data relating to a real object and/or at least one reflection object associated with the real object; and analyzing the data relating to the at least one combined object to determine at least one characteristic associated with an interior space and/or exterior space of the elevator car.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates a flow diagram of a method according to an example embodiment.

FIG. 2 illustrates a system according to an example embodiment.

FIG. 3A illustrates an image provided by a camera arranged in an elevator car according to an example embodiment.

FIG. 3B illustrates an image provided by a camera arranged in an elevator car according to an example embodiment.

FIG. 3C illustrates an image provided by a camera arranged in an elevator car according to an example embodiment.

FIG. 3D illustrates an image provided by a camera arranged in an elevator car according to an example embodiment.

FIG. 4A illustrates an image provided by a time of flight sensor arranged in an elevator car according to an example embodiment.

FIG. 4B illustrates an image provided by a black-and-white camera arranged in an elevator car according to an example embodiment.

FIG. 5 illustrates a block diagram of an apparatus according to an example embodiment.

### DETAILED DESCRIPTION

Various examples and embodiments discussed below illustrate a solution in which sensor data relating to both real objects sensed by at least one sensor associated with an elevator car and reflection objects of the real objects may be used in determining at least one characteristic associated with an interior space and/or exterior space of the elevator car.

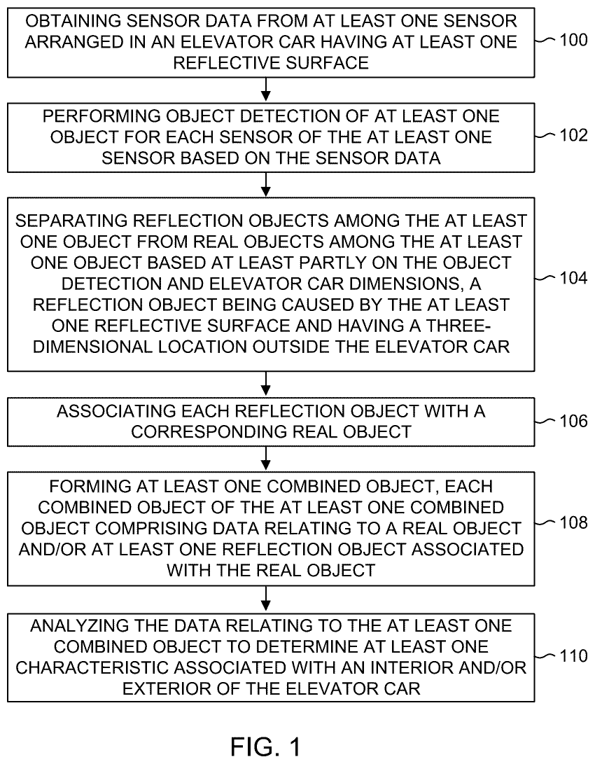

FIG. 1 illustrates a flow diagram of a method according to an example embodiment.

At 100, sensor data may be obtained from at least one sensor arranged in an elevator car having at least one reflective surface. The sensor may be, for example, a camera, a time of flight camera, a lidar, a radar or a thermal camera. The sensor may provide two-dimensional data or three-dimensional data about the interior of the elevator car.

At 102, object detection of at least one object may be performed for each sensor of the at least one sensor based on the sensor data. The objection detection may be implemented using any appropriate object detection technology that is able to process two-dimensional data and/or three-dimensional data.

At 104, reflection objects among the at least one object may be separated from real objects among the at least one object based at least partly on the object detection and elevator car dimensions, a reflection object being caused by the at least one reflective surface and having a three-dimensional location outside the elevator car.

The term “real object” may refer, for example, to a passenger or an item that resides inside elevator car. The dimensions of the elevator car may be available as configured information. Thus, objects residing inside the elevator car can be categorized as real objects. In another example embodiment, a real object may reside also outside the elevator car, for example, in an elevator lobby. In an example embodiment, the three-dimensional location of the real object may be determined based on sensor data of a sensor, for example, the time of flight camera, the lidar or the radar. The term “reflection object” may refer, for example, to a reflection of the corresponding real object from a reflecting surface of the elevator car, for example, a mirror, a reflecting wall surface, a reflecting door surface etc. As the dimensions of the elevator car are known, the reflection objects appear to be outside the elevator car.

At 106, each reflection object is associated with a corresponding real object. As the elevator dimensions and the sensor locations are known and constant, the location of the corresponding real object may be solved from the three-dimensional location of the reflection object.

At 108, at least one combined object may be formed, each combined object of the at least one combined object comprising data relating to a real object and/or at least one reflection object associated with the real object. In an example embodiment, some combined objects may not have any reflection objects and some combined objects may not have real objects. This may be possible, for example, if the real object is outside the field of view of the sensor or if another real object is blocking the view from the sensor to the real object.

At 110, the data relating to the at least one combined object is analyzed to determine at least one characteristic associated with an interior space and/or exterior space of the elevator car. The characteristic may be, for example, the number of passengers in the elevator car, a passenger type (for example, a maintenance person) in the elevator car, an object type in the elevator car, an indication of an open elevator door, an indication of a closed elevator door and/or information about at least one object outside the elevator car in a lobby area, for example, at least passenger waiting for the elevator car.

In an example embodiment, it may be determined that the data relating to the at least one combined object identifies at least one passenger. A passenger may be identified based on an identified real object, an identified reflection object or based on both an identified real object and an identified reflection object. For example, a passenger may not be detected as a real object based on the sensor data, for example, a camera image, but only as a reflection object. However, the passenger can still be determined to reside inside the elevator car based on the reflection object. Further, the same passenger may be identified both as a real object and a reflection object. Further, a passenger may be identified only as a real object as there are no reflections caused by the at least one reflective surface. By summing the identified passengers it is possible to determine the number of passengers in the elevator car.

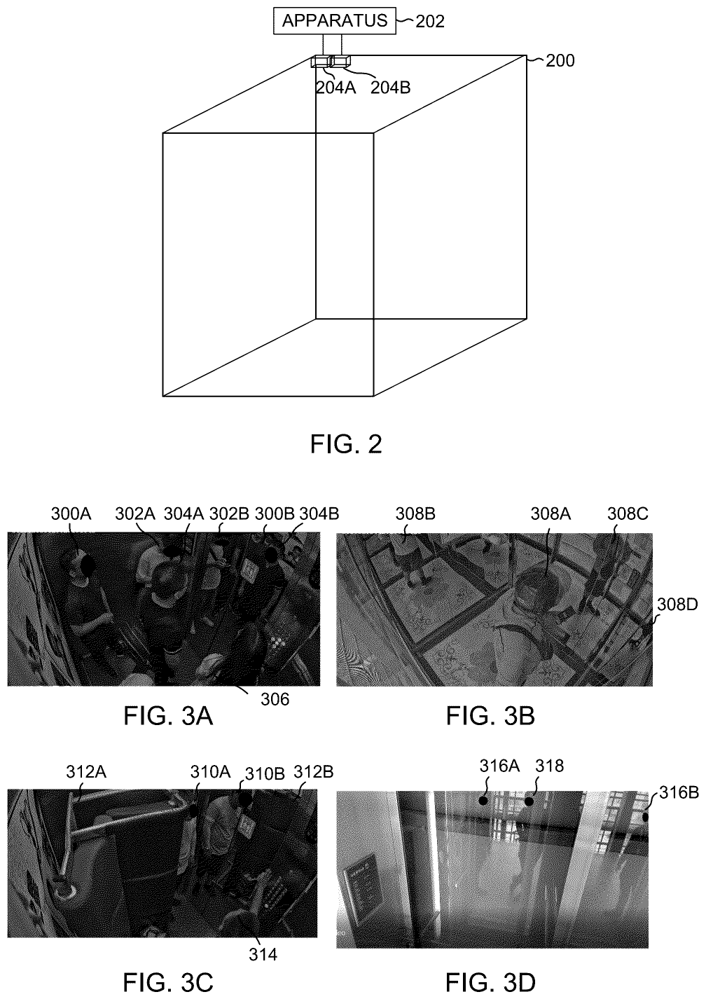

FIG. 2 illustrates a system according to an example embodiment. At least one sensor 204A, 204B may be arranged inside an elevator car 200 to sense the interior of the elevator car 200. The at least one sensor 204A, 204B may comprise, for example, at least one of a camera, a time of flight camera, a lidar, a radar and a thermal camera. The sensor may provide two-dimensional data or three-dimensional data about the interior of the elevator car. The at least one sensor 204A, 204B are communicatively connected to an apparatus 202. The connection between the apparatus 202 and the at least one sensor 204A, 204B may be wired or wireless. The apparatus 202 may be aware of the internal dimensions of the elevator car 200 and configured to implement the method discussed in more detail in FIG. 1 and its description. In an example embodiment, the apparatus 202 may be an internal entity of the elevator system. In another example embodiment, the apparatus 202 may be a cloud-based entity, for example, a network server.

FIG. 3A illustrates an image provided by a camera arranged in an elevator car according to an example embodiment. The image illustrates four real objects 300A, 302A, 304A, 306, i.e. passengers in the elevator car. The doors of the elevator car act as reflective surfaces and provide reflection objects 300B, 302B, 304B, i.e. reflections of the passengers.

FIG. 3B illustrates an image provided by a camera arranged in an elevator car according to an example embodiment. The image illustrates one real object 308A, i.e. a passenger in the elevator car. The doors and side walls of the elevator car act as reflective surfaces and provide reflection objects 308B, 308C, 308D, i.e. reflections of the passenger.

FIG. 3C illustrates an image provided by a camera arranged in an elevator car according to an example embodiment. The image illustrates three real objects 310A, 312A, 314, i.e. two passengers and a sofa in the elevator car. The doors of the elevator car act as reflective surfaces and provide reflection objects 310B, 312B, i.e. reflections of the passenger 310A and the sofa 312A.

FIG. 3D illustrates an image provided by a camera arranged in an elevator car according to an example embodiment. The image illustrates no real objects inside the elevator car. However, the rear wall of the elevator car acts as a reflecting surface and provides reflection objects 316A, 316B, i.e. reflections of two people waiting for the elevator in the lobby area. In addition to the reflection objects 316A, 316B, the side wall of the elevator provides another reflection object 316B. In an example embodiment, information about the passengers waiting in the lobby area may be used, for example, for controlling the elevator car. The passengers in the lobby area may not have placed an elevator call, and if there are no existing calls allocated to the elevator, the elevator car may be kept at the floor or close to the floor where the passengers in the lobby area were detected.

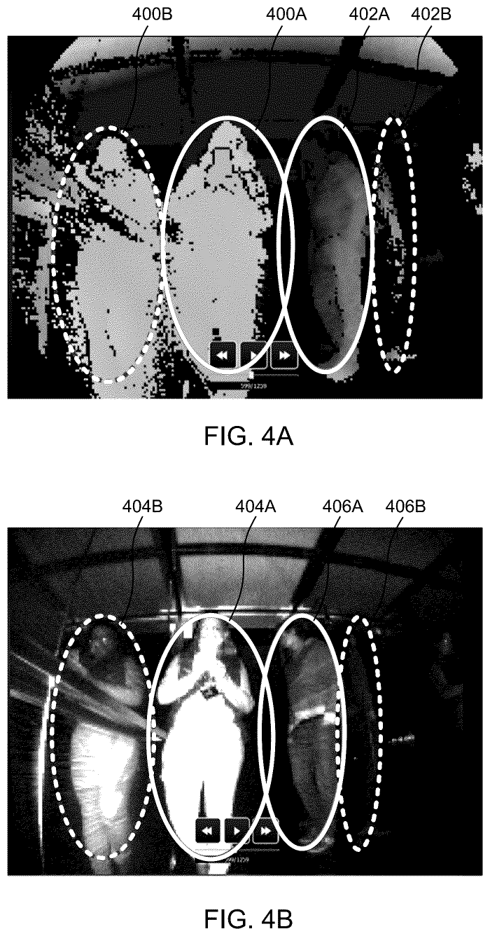

FIG. 4A illustrates an image provided by a time of flight sensor arranged in an elevator car according to an example embodiment. The image illustrates two real objects 400A, 402A, i.e. passengers in the elevator car. The side walls of the elevator car act as reflective surfaces and provide reflection objects 400B, 402B, i.e. reflections of the passengers.

FIG. 4A illustrates an image provided by a camera arranged in an elevator car according to an example embodiment. The image illustrates two real objects 400A, 402A, i.e. passengers in the elevator car. The side walls of the elevator car act as reflective surfaces and provide reflection objects 400B, 402B, i.e. reflections of the passengers.

FIG. 4B illustrates an image provided by a black-and-white camera arranged in an elevator car according to an example embodiment. The image illustrates two real objects 404A, 406A, i.e. passengers in the elevator car. The side walls of the elevator car act as reflective surfaces and provide reflection objects 404B, 406B, i.e. reflections of the passengers.

The images illustrated in FIGS. 3A-3D and 4A-4B provide some examples of real objects and reflection objects provided sensed by at least one sensor. When using also reflections, it is possible to gain more information about the objects, for example, passengers or items in an elevator car, and in another example embodiment also about the functionality of some parts of the elevator car and/or passengers or items outside the doors of the elevator car. For example, for elevators with two doors in an opposite side of the elevator car, it is possible to consider the reflections of the second door in order to decide if the second door is open or closed without having a direct line of sight (LOS) to both doors. Further, the sensor data obtained about the combined objects, i.e. real objects and reflection objects, may be used to calculate the number of people in the elevator car. In another example embodiment, the data relating to the at least one combined object may be analyzed to determine at least one characteristic associated with or the at least one real object in the elevator car. For example, the real objects in the elevator may be classified based on their micro-Doppler signatures. The information gained from reflections may be very useful, for example, for classifying a scooter from a bike. From the reflections, it might be more visible what type of micro-Doppler signature a wheel has in case the direct line of sight view does not provide this information.

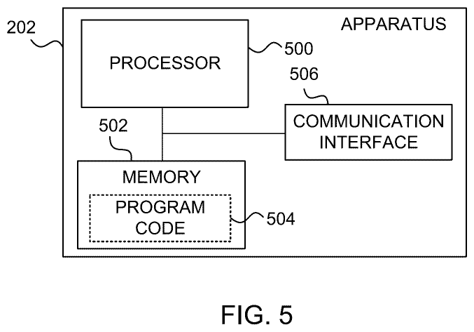

FIG. 5 illustrates a block diagram of an apparatus 202 according to an example embodiment. The apparatus 202 comprises one or more processors 500, and one or more memories 502 that comprise computer program code. The apparatus 202 may also include an input/output module (not shown in FIG. 5), and/or a communication interface 506 for wired and/or wireless communication. Although the apparatus 202 is depicted to include only one processor 500, the apparatus 202 may include more than one processor. In an example embodiment, the memory 502 is capable of storing instructions, such as an operating system and/or various applications.

Furthermore, the processor 500 is capable of executing the stored instructions. In an example embodiment, the processor 500 may be embodied as a multi-core processor, a single core processor, or a combination of one or more multi-core processors and one or more single core processors. For example, the processor 500 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 500 may be configured to execute hard-coded functionality. In an example embodiment, the processor 500 is embodied as an executor of software instructions, wherein the instructions may specifically configure the processor 500 to perform the algorithms and/or operations described herein when the instructions are executed, for example, the steps discussed relating to FIG. 1.

The memory 502 may be embodied as one or more volatile memory devices, one or more non-volatile memory devices, and/or a combination of one or more volatile memory devices and non-volatile memory devices. For example, the memory 502 may be embodied as semiconductor memories (such as mask ROM, PROM (programmable ROM), EPROM (erasable PROM), flash ROM, RAM (random access memory), etc.).

In an embodiment, the at least one memory 502 may store program instructions 504 that, when executed by the at least one processor 500, cause the apparatus 202 to perform the functionality of the various embodiments discussed herein. Further, in an embodiment, at least 500 and the memory 502 may one of the processor constitute means for implementing the discussed functionality. Further, the apparatus 202 may be configured to obtain sensor data from at least one sensor arranged in an elevator car having at least one reflective surface; perform object detection of at least one object for each sensor of the at least one sensor based on the sensor data; separate reflection objects among the at least one object from real objects among the at least one object based at least partly on the object detection and elevator car dimensions, a reflection object being caused by the at least one reflective surface and having a three-dimensional location outside the elevator car; associate each reflection object with a corresponding real object, forming at least one combined object, each combined object of the at least one combined object comprising data relating to a real object and/or at least one reflection object associated with the real object; and analyze the data relating to the at least one combined object to determine at least one characteristic associated with an interior space and/or exterior space of the elevator car.

At least one of the examples and embodiments disclosed above may enable a solution in which reflections caused by at least one reflective surface of an elevator car can be used for providing additional information about the objects inside the elevator car and/outside the elevator car.

Example embodiments may be implemented in software, hardware, application logic or a combination of software, hardware and application logic. The example embodiments can store information relating to various methods described herein. This information can be stored in one or more memories, such as a hard disk, a solid state drive (SSD), an optical disk, a magneto-optical disk, an RAM, and the like. One or more databases can store the information used to implement the example embodiments. The databases can be organized using data structures (e.g., records, tables, arrays, fields, graphs, trees, lists, and the like) included in one or more memories or storage devices listed herein. The methods described with respect to the example embodiments can include appropriate data structures for storing data collected and/or generated by the methods of the devices and subsystems of the example embodiments in one or more databases.

The components of the example embodiments may include computer readable medium or memories for holding instructions programmed according to the teachings and for holding data structures, tables, records, and/or other data described herein. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

While there have been shown and described and pointed out fundamental novel features as applied to preferred embodiments thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1. A method comprising:
obtaining sensor data from at least one sensor arranged in an elevator car having at least one reflective surface;
performing object detection of at least one object for each sensor of the at least one sensor based on the sensor data;
separating reflection objects among the at least one object from real objects among the at least one object based at least partly on the object detection and elevator car dimensions, a reflection object being caused by the at least one reflective surface and having a three-dimensional location outside the elevator car;
associating each reflection object with a corresponding real object;
forming at least one combined object, each combined object of the at least one combined object comprising data relating to a real object and/or at least one reflection object associated with the real object; and
analyzing the data relating to the at least one combined object to determine at least one characteristic associated with an interior space and/or exterior space of the elevator car.

2. The method according to claim 1, wherein separating reflection objects among the at least one object from real objects among the at least one object based at least partly on the object detection and elevator car dimensions comprises:
determining a three-dimensional location of the at least one object based on the sensor data; and
separating the reflection objects among the at least one object from the real objects among the at least one object based at least partly on the three-dimensional location of the at least one object and the elevator car dimensions.

3. The method according to claim 1, further comprising:
determining that the data relating to the at least one combined object identifies at least one passenger; and
determining the at least one characteristic based on the data, wherein the at least one characteristic comprises the number of passengers in the elevator car.

4. The method according to claim 1, wherein the at least one characteristic comprises information identifying a passenger type in the elevator car.

5. The method according to claim 1, wherein the at least one characteristic comprises information identifying an object type in the elevator car.

6. The method according to claim 1, wherein the at least one characteristic comprises an indication of an open elevator door.

7. The method according to claim 1, wherein the at least one characteristic comprises an indication of a closed elevator door.

8. The method according to claim 1, wherein the at least one characteristic comprises information about at least one object outside the elevator car in a lobby area.

9. The method according to claim 1, wherein the at least one sensor comprises at least one of the following:
a camera;
a time of flight camera;
a lidar;
a radar; and
a thermal camera.

10. The method according to claim 1, further comprising:
classifying the at least one real object based on the at least one characteristic.

11. An apparatus comprising:
at least one processor; and
at least one memory storing instructions that, when executed by the at least one processor, cause the apparatus to at least perform:
obtaining sensor data from at least one sensor arranged in an elevator car having at least one reflective surface;
performing object detection of at least one object for each sensor of the at least one sensor based on the sensor data;
separating reflection objects among the at least one object from real objects among the at least one object based at least partly on the object detection and elevator car dimensions, a reflection object being caused by the at least one reflective surface and having a three-dimensional location outside the elevator car;
associating each reflection object with a corresponding real object;
forming at least one combined object, each combined object of the at least one combined object comprising data relating to a real object and/or at least one reflection object associated with the real object; and
analyzing the data relating to the at least one combined object to determine at least one characteristic associated with an interior space and/or exterior space of the elevator car.

12. The apparatus according to claim 11, wherein the at least one memory (502) stores instructions that, when executed by the at least one processor, cause the apparatus (202) to at least perform:
determining a three-dimensional location of the at least one object based on the sensor data; and
separating the reflection objects among the at least one object from the real objects among the at least one object based at least partly on the three-dimensional location of the at least one object and the elevator car dimensions.

13. The apparatus according to claim 11, wherein the at least one memory stores instructions that, when executed by the at least one processor, cause the apparatus to at least perform:
determine that the data relating to the at least one combined object identifies at least one passenger;
determine at least one characteristic based on the data, wherein the at least one characteristic comprises the number of passengers in the elevator car.

14. The apparatus according to claim 11, wherein the at least one characteristic comprises information identifying a passenger type in the elevator car.

15. The apparatus according to claim 11, wherein the at least one characteristic comprises information identifying an object type in the elevator car.

16. The apparatus according to claim 11, wherein the at least one characteristic comprises an indication of an open elevator door.

17. The apparatus according to claim 11, wherein the at least one characteristic comprises an indication of a closed elevator door.

18. The apparatus according to claim 11, wherein the at least one characteristic comprises information about at least one object outside the elevator car in a lobby area.

19. The apparatus according to claim 11, wherein the at least one sensor comprises at least one of the following:
a camera;
a time of flight camera;
a lidar;
a radar; and
a thermal camera.

20. The apparatus according to claim 11, wherein the at least one memory stores instructions that, when executed by the at least one processor, cause the apparatus to at least perform:
classifying the at least one object based on the at least one characteristic.

21. A non-transitory computer readable medium storing a computer program comprising instructions which, when the program is executed by at least one processor, cause an apparatus to perform the method of claim 1.

22. A non-transitory computer-readable medium comprising a computer program comprising instructions which, when the program is executed by at least one processor, cause an apparatus to perform the method of claim 2.

23. An elevator system comprising:
an apparatus according to claim 11; and
at least one sensor arranged in an elevator car and configured to provide sensor data to the apparatus.
